(19) United States
(12) Patent Application Publication
(10) Pub. No.: US 2002/0148459 A1
(43) Pub. Date: Oct. 17, 2002

(54) Method and apparatus for grilling and broiling foodstuffs

(76) Inventors: Bobby O. McCarty, Kosciusko, MS (US); Rodger D. James, West, MS (US); Joel O. McCarty, Kosciusko, MS (US)

Correspondence Address: JENKENS & GILCHRIST, P.C., 225 WEST WASHINGTON, SUITE 2600, CHICAGO, IL, 60606, US

(21) Appl. No.: 09/939,499

(22) Filed: Aug. 23, 2001

Related U.S. Application Data
(60) Provisional application No. 60/283,964, filed on Apr. 16, 2001.

(51) Int. Cl. F24B 3/00; A47J 37/00

(52) U.S. Cl. 126/25 R

(57) ABSTRACT

An apparatus and method for grilling and broiling food including a housing defining an upper cooking chamber for grilling food and a lower cooking chamber for broiling food. A heat source between the upper and lower cooking chambers supplies heat to the upper and lower cooking chambers. A heat reflector above the heat source reflects heat from the heat source downwardly into the lower cooking chamber.

### CROSS-REFERENCE TO RELATED APPLICATION

This application claims the benefit of priority of U.S. Provisional Patent Application Serial No. 60/283,964 filed on Apr. 16, 2001.

### BACKGROUND

1. Technical Field of the Invention

The present invention relates to a cooking apparatus and, more particularly, but not by way of limitation, to an improved cooking apparatus that includes both a grill and broiler assembly.

2. History of Related Art

The cooking of food, particularly meat, in an outdoor cooking facility became exceedingly popular in the 20^{th} Century. In the 1950's it was common to find homes constructed with permanent outdoor grills, or barbecue pits made of brick and/or other stone. These cooking facilities formed the nucleus of a backyard area around which a family and neighbors could assemble and enjoy one's company as well as the food cooked on the grill. Although effective in providing an area for barbecuing meat, the permanent structures were inherently expensive and not everyone could afford them.

Innovations in the outdoor grilling arena were subsequently manifested in the portable grill. These grills were often made of heavy metal and placed on wheels to allow for movement into various areas of a yard or porch area. This design permitted not only portability but also economically feasible grilling facilities.

More contemporary innovations in outdoor grilling have included the use of lighter weight and less expensive materials in the fabrication of the barbecue grill. Other innovations have included the creation of upstanding units for the smoking of meat and the like. Such units and the prior innovations of outdoor grills typically utilized charcoal and/or wood for the generation of heat. More contemporary units have included the use of natural gas and/or propane for generating the necessary heat. These gas fired barbecue systems have found widespread popularity due to the fact that it is not necessary to replace the charcoal and/or wood for the outdoor barbecue operation.

Today, many outdoor barbecue systems are elaborate in construction, including inlaid tile and other amenities that facilitate the cooking operation in an ascetically pleasing manner. In many instances the more elaborate outdoor barbecue systems even mimic the accouterments of a kitchen area designated for cooking, such as the construction of open-faced burners disposed adjacent the barbecue grill area for either frying foods, boiling water, etc., at the same time the operator grilled food. It would be an advantage, therefore, to provide yet further similarities to indoor kitchen cooking areas by creating a single system facilitating both grilling and broiling operations. It is well-known that broiling is often preferred in various recipes. Thus, it would be advantageous to have an assembly that is capable of broiling food as well as grilling food. The present invention provides for a method of and apparatus for grilling and broiling foodstuffs in a manner facilitating both ease of operation and simplicity of cleaning. The present invention also allows a user to grill and broil different foodstuffs simultaneously using the same heat source, thereby saving energy.

Typically, during the grilling process, grease and drippings from the grilling food fall on the heat source creating vapors and smoke that may affect the taste of the food prepared. It has also been shown that such vapors and smoke may contain carcinogens. Also, grease and drippings from the grilling food may fall past the heat source onto whatever may be below. The present invention minimizes the burning of grease and drippings from the grilled food, such that very little smoke and vapors are produced that may affect the taste of the food being grilled or broiled. This minimization of the production of smoke and vapors also reduces the production of carcinogens. The present invention also keeps all grease and drippings produced by the grilled food from falling past the heat source and onto the broiling food. Furthermore, the present invention saves energy by allowing the user to grill and broil different foodstuffs simultaneously using the same heat source.

### SUMMARY OF THE INVENTION

The present invention relates to an apparatus for grilling and broiling food including a housing defining an upper cooking chamber for grilling food and a lower cooking chamber for broiling food. The apparatus also contains a heat source between the upper and lower cooking chambers for supplying heat to the upper and lower cooking chambers. The apparatus also contains a heat reflector above the heat source for reflecting heat from the heat source downwardly into the lower cooking chamber.

The present invention also relates to a method for grilling and broiling food simultaneously by providing a housing that defines an upper cooking chamber for grilling food and a lower cooking chamber for broiling food, placing food to be grilled on an upper grate within the upper cooking chamber, and placing food to be broiled on a lower grate within the lower cooking chamber. The method also comprises activating a heat source between the upper and lower cooking chambers such that the heat source produces sufficient heat to grill the food to be grilled and broil the food to be broiled. The method also comprises reflecting the heat from the heat source downwardly into the lower cooking chamber.

### BRIEF DESCRIPTION OF THE DRAWINGS

A more complete understanding of embodiments of the present invention can be achieved by reference to the following detailed description when taken in conjunction with the accompanying Drawings wherein:

FIG. 1 is a perspective, exploded view of a grill and broiler assembly constructed according to the principles of the present invention;

FIG. 2 is a perspective view of the flame spreader of FIG. 1;

FIG. 3 is a front elevational, cross-sectional view of the assembly of FIG. 1 illustrating the grilling and broiling process inside the housing;

FIG. 4 is a bottom plan view of the housing of FIG. 3;

FIG. 5 is a side elevation view of the interior surface of one end of the lower cooking chamber of the housing of FIG. 3.

### DETAILED DESCRIPTION

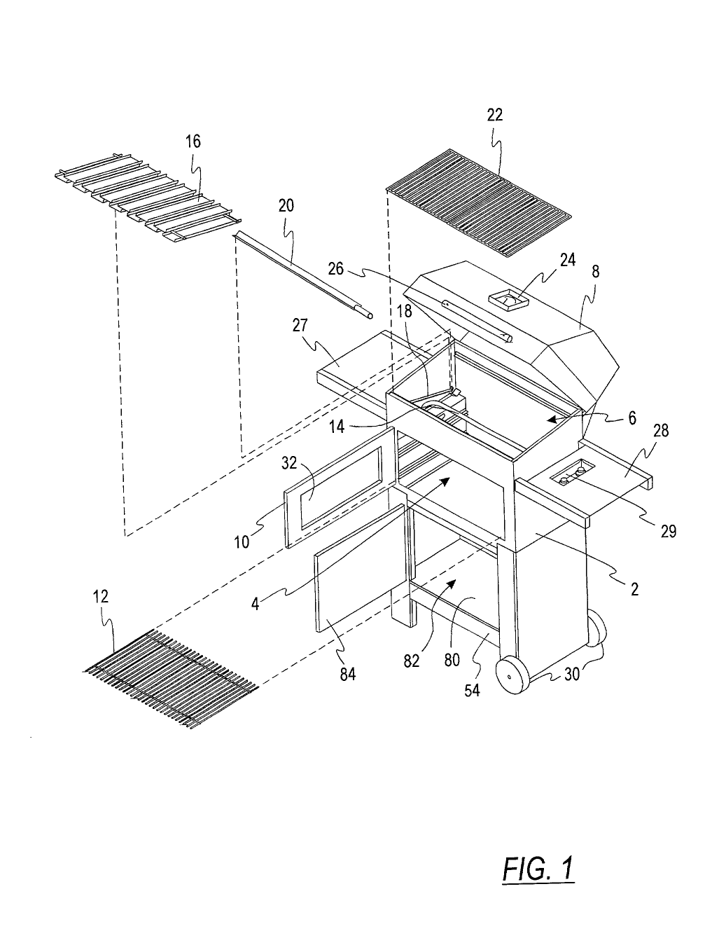

Referring initially to FIG. 1, the preferred embodiment for an apparatus for grilling and broiling food is shown in an exploded, perspective view. The apparatus includes a housing 2 attached to a frame 54. The housing 2 defines an upper opening 6 and a first frontal opening 4. The frame 54 defines a second frontal opening 80. In order to close the respective openings, a lid 8 and a first door 10 are attached to the housing 2. In order to close the second frontal opening, a second door 84 is pivotally attached to the frame 54. A thermometer 24 and a handle 26 are attached to the lid 8. The first door 10 includes a window 32. A left support surface 27 and a right support surface 28 are attached to the left and right outer sides of the housing 2 respectively. An adjustable valve 29 is attached to the housing 2. Also, wheels 30 are attached to a lower end of the frame 54.

Internally, the housing 2 encompasses a lower grate 12, a heat source 14 located above the lower grate 12, a flame spreader 16 located above the heat source 14, and an upper grate 22 located above the flame spreader 16. The flame spreader 16 is mounted at an angle on an angled flame spreader mount 18. A grease catcher 20 is located below the lower end of the flame spreader 16.

In order to provide the user with access to the upper grate 22, the lid 8 is pivotally attached to the housing 2. To provide the user access to the lower grate 12, the first door 10 is pivotally attached to the housing 2. For the purposes of allowing a user to gauge the broiling rate of the apparatus a window 32 is disposed within the first door 10. Also, To provide the user access to a storage area 82, the second door 84 is pivotally attached to the frame 54. Furthermore, to allow a user to monitor and adjust the temperature inside the housing 2, a thermometer 24 is attached to the lid 8 and an adjustable valve 29 is attached to the housing 2 such that the user can adjust the fuel flow rate to control the amount of heat emitted by the heat source 14. The heat source 14 shown in the preferred embodiment of FIG. 1 includes a fuel line 14a adapted to be connected to a fuel source such as a propane tank, but any other type of heat generating structure may be used as long as the heat generated is sufficient to grill and broil food simultaneously. If a propane tank is used as the fuel source, it may be stored in the storage area 82. To provide the user with space to rest his or her cooking utensils, plates, etc., left and right support surfaces 27, 28 are attached to the left and right outer sides of the housing 2. To facilitate ease of transport of the apparatus, wheels 30 are attached to a lower end of the frame 54. To allow for removability of the housing 2 from the frame 54, two removable pins 86 secure the lower portion of the housing 2 to the upper portion of the frame 54. Note that it is contemplated by the inventor and understood by those of skill in the art that other securing devices may be substituted for the removable pins 86 that would allow for the removal/securing of the housing 2 to the frame 54.

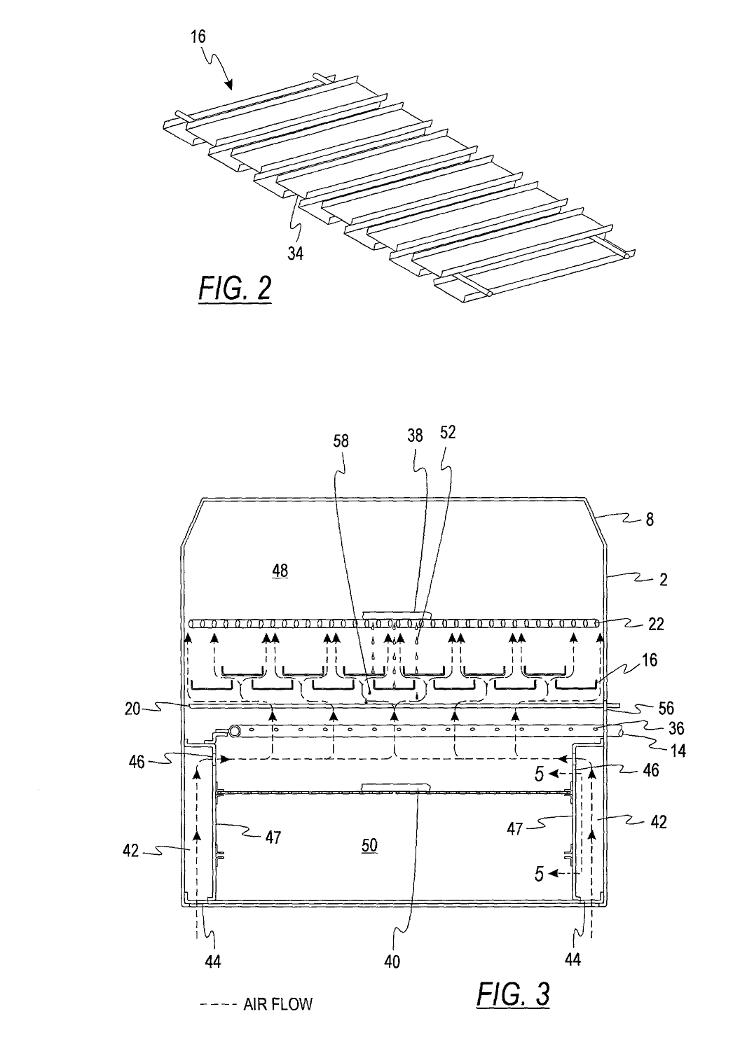

FIG. 2 illustrates the cooking process carried out in the preferred embodiment. In order to grill food with the apparatus in the upper cooking chamber 48, food 38 is placed on the upper grate 22. To generate the heat necessary to grill the food 38, a gaseous fuel is fed into the heat source 14 which comprises a perforated U-shaped tube. The fuel is ignited as it is released through the perforations 36 of the pipe. In order to grill the food 38 evenly, the rising flames from the heat source 14 impinge upon the flame spreader 16 such that the flames are distributed substantially evenly below the upper grate 22. Because the heat source 14 of the present invention is not limited to a flame-producing heat source, the flame spreader 16 does not have to necessarily spread flames; it may just operate as a heat distributor/reflector to distribute heat relatively evenly below the upper grate 22 and reflect heat down to the lower grate 12.

The air supply for the heat source 14 is derived from a pair of air intake chambers 42 at opposite ends of the lower cooking chamber 50. Ambient air is drawn into the chambers 42 through bottom intake ports 44 and passes upwardly through the chambers to a pair of exit ports 46 near the tops of the inside walls 47 of the chambers 42. The air is discharged from the ports 46 directly beneath the burner tube 14 so as to supply the oxygen needed for combustion of the fuel being discharged from the apertures in the burner tube 14. It will be noted that the air-intake chambers 42 thus bypass the major portion of the lower cooking chamber 50 so that the upward air flow does not disturb the cooking process in the lower cooking chamber.

Above the burner tube 14, the combustion products, excess air and heat pass upwardly through the spaces between adjacent channels 34 in the lower tier of channels in the flame spreader 16, around the bottom surfaces of the channels 34 in the upper tier of the flame spreader, and then up through the spaces between adjacent channels 34 in the upper tier to the upper grate 22. This flow pattern supplies heat to the bottom surfaces of all the channels 34 in the flame spreader 16, which in turn reflects a substantial portion of that heat downwardly into the broiling chamber 50. At the same time, the flame spreader 16 distributes the heat across the entire area of the upper grate 22 so that food can be grilled anywhere on that grate.

The cooking fumes, air and heat above the upper grate 22 are ultimately discharged from the upper cooking chamber 48 through a space 60 between the rear wall of the housing 2 and the lower edge of the rear wall of the lid 8. To reach this exit space 60, the gases flow upwardly to the inside surface of the lid 8, and then rearwardly along that surface and down along the rear wall of the lid 8 to the space 60. This flow pattern serves to distribute the heat evenly throughout the upper cooking chamber 50 so that the cooking conditions are substantially uniform throughout that chamber.

For the purposes of allowing the drippings and grease 52 to pass through the upper grate 22, the upper grate 22 of the preferred embodiment is shown constructed of spaced parallel bars such that the drippings and grease may fall through the upper grate 22. The upper grate 22 may be constructed in any manner that supports the food being grilled 38 while allowing the drippings and grease 52 to pass through the upper grate 22.

In order to keep the drippings and grease 52 emitted from the grilling food 38 from falling into the lower cooking chamber 50, the flame spreader 16 is constructed of two overlapping tiers of U-shaped channels 34, seen in FIGS. 2 and 3, such that it receives substantially all of the drippings and grease 52 that fall through the upper grate 22 from the grilling food 38. The U-shaped channels may also have a different cross section such as W-shaped, V-shaped, semi-circular-shaped, or any other shape that prohibits the drippings and grease 52 from flowing off the sides of the channels. Because vapors and smoke produced by the burning of drippings and grease may contaminate the taste of food, the flame spreader 16 is disposed within the housing 2 at an angle such that the drippings and grease 52 received from the grilling food 38 flow off the lower end of the flame spreader 16 into the grease catcher 20, which channels the drippings and grease 52 through the grease outlet 56. This continuous draining minimizes the amount of drippings and grease 52 that are exposed to the heat emitted from the heat source 14 for a period of time long enough to char the drippings and grease 52.

In order to facilitate cleanup, a user may mount a container to the housing 2 in order to catch the drippings and grease 52 the flow out of the housing 2 through the grease outlet 56.

To broil food in the lower cooking chamber 50, food 40 is placed on the lower grate 12. To generate the heat necessary to grill the food 40, a gaseous fuel is fed into the heat source 14 and is ignited as it is released through the perforations 36 of the pipe. To reflect the necessary heat down to the food 40, the flame spreader 16 is constructed of U-shaped channels 34 which have relatively wide undersides which have a combined surface area sufficient to reflect enough heat from the heat source 14 to broil the food 40 on the lower grate 12. As stated above, the U-shaped channels 34 may have a different cross sections and, therefore, different underside geometries, the only limitation (other that the one stated above regarding the grease flow) being that the underside of the flame spreader 16 reflects enough heat to broil the food 40 on the lower grate 12.

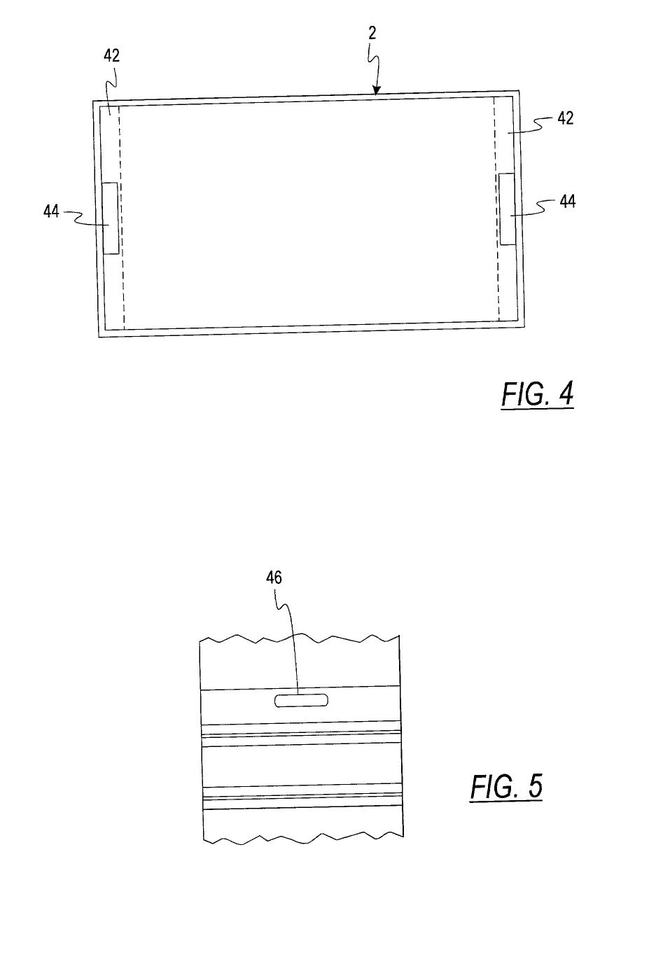

To supply the necessary air to the heat source 14, a pair of air intake chambers 42 at opposite ends of the lower cooling chamber 50 allow air to be drawn into the housing 2 through air inlets 44, seen in FIGS. 3 and 4, channeled upwardly through the chambers 42, and out slots 46 to the heat source 14.

1. An apparatus for grilling and broiling food, said apparatus comprising:
a housing defining an upper cooking chamber for grilling food and a lower cooking chamber for broiling food;
a heat source between said upper and lower cooking chambers for supplying heat to said upper and lower cooking chambers; and
a heat reflector above said heat source for reflecting heat from said heat source downwardly into said lower cooking chamber.

2. The apparatus of claim 1, further comprising at least one air intake chamber below said heat source for supplying air to said heat source, said air intake chamber isolating the air from said lower cooking chamber.

3. The apparatus of claim 1, wherein said heat reflector is designed to diffuse the heat from said heat source throughout said upper cooking chamber.

4. A method of grilling and broiling food simultaneously, said method comprising:
providing a housing defining an upper cooking chamber for grilling food and a lower cooking chamber for broiling food;
placing food to be grilled on an upper grate within said upper cooking chamber;
placing food to be broiled on a lower grate within said lower cooking chamber;
activating a heat source between said upper and lower cooking chambers such that said heat source produces sufficient heat to grill said food to be grilled and broil said food to be broiled; and
reflecting the heat from said heat source downwardly into the lower cooking chamber.

5. The method of claim 4, further comprising supplying air to the heat source through an air intake chamber below said heat source, said air intake chamber isolating the air from said lower cooking chamber.

6. The method of claim 4, further comprising diffusing the heat from said heat source throughout the upper cooking chamber.

7. An apparatus for grilling and broiling foodstuffs, said apparatus comprising:
a frame;
a housing mounted to said frame and defining an enclosure for said foodstuffs with upper and frontal openings;
a closeable lid mounted on said housing for selectively closing said upper opening;
a closeable door mounted on said housing for selectively closing said frontal opening;
a heat source adapted for cooking said foodstuffs and secured within said housing generally between said upper and frontal openings;
an upper grate disposed within said housing above said heat source and below said upper opening for supporting said foodstuffs such that said foodstuffs can be grilled by said heat source; and
a lower grate disposed within said housing below said heat source for supporting said foodstuffs such that said foodstuffs can be broiled by said heat source.

8. The apparatus of claim 7, wherein said heat source emits flames.

9. The apparatus of claim 8, further comprising a flame spreader disposed within said housing above said heat source and below said upper grate such that said flames from said heat source impinge upon said flame spreader, said flame spreader adapted to spread said flames substantially evenly below said upper grate, said flame spreader further adapted to receive substantially all drippings that are emitted from said foodstuffs being grilled, said flame spreader disposed within said housing at an angled position such that said drippings emitted from said foodstuffs being grilled tend to run toward the lower end of said flame spreader due to gravitational forces.

10. The apparatus of claim 9, wherein said housing further defines a grease outlet, said apparatus further comprising a grease catcher within said housing below the lower end of said flame spreader, said grease catcher adapted to receive said drippings that run off the lower end of said flame spreader, said grease catcher further adapted to channel said drippings through said grease outlet.

11. The apparatus of claim 9, wherein said flame spreader is removable.

12. The apparatus of claim 10, wherein said grease catcher is removable.

13. The apparatus of claim 7, wherein said lid is pivotally attached to said housing.

14. The apparatus of claim 7, wherein said door is pivotally attached to said housing.

15. The apparatus of claim 7, further comprising a thermometer attached to said lid for allowing a user to monitor the temperature inside said housing.

16. The apparatus of claim 7, further comprising wheels connected to a lower end of said frame enabling said housing to be easily transported.

17. The apparatus of claim 7, further comprising a left support surface attached to the left outer side of said frame adjacent to said housing, said left support surface being substantially planar.

18. The apparatus of claim 17, further comprising a right support surface attached to a right outer side of said frame adjacent to said housing, said right support surface being substantially planar.

19. The apparatus of claim 7, wherein said heat source is of the types producing combustion from a gaseous fuel and comprises a perforated pipe adapted to guide said gaseous fuel through the perforations and said apparatus further includes means for connecting said perforated pipe to a source of said gaseous fuel.

20. The apparatus of claim 19, further comprising at least one adjustable valve mounted to said frame adjacent to said housing allowing adjustment of the amount of said gaseous fuel flowing to said heat source.

21. The apparatus of claim 7, wherein said door further includes a transparent section comprising a window for facilitating the observation of said broiling of said foodstuffs.

22. The apparatus of claim 7, wherein said housing defines at least one air intake chamber, said at least one air intake chamber defining at least one air inlet located at the lower end of said housing, said at least air intake chamber further defining an air outlet located generally above said lower grate and generally below said heat source.

23. The apparatus of claim 7, wherein said frame defines a lower enclosure for storage.

24. The apparatus of claim 7, wherein said housing is mounted to said frame by way of removable pins such that said housing may be removed from said frame when said removable pins are removed.

25. A combined broiler and grill system for cooking foodstuffs, said system comprising:
a frame;
a housing mounted to said frame;
a heat source disposed within said housing and adapted for generating sufficient heat to broil and grill said foodstuffs placed within said housing;
an upper grate disposed within said housing above said heat source;
an upper cooking chamber affording access to said upper grate;
a lower grate disposed within said housing below said heat source;
a lower cooking chamber affording access to said lower grate; and
means for controlling the heat generated by said heat source for regulating the broiling and grilling of said foodstuffs placed within said housing.

26. The system of claim 25, wherein said heat source emits flames;

27. The system of claim 26, further comprising flame spreading means disposed within said housing located above said heat source and below said upper grate for spreading said flames from said heat source substantially evenly below said upper grate, said flame spreading means further adapted to receive substantially all drippings that are emitted from said foodstuffs being grilled, said flame spreading means disposed in said housing at an angled position such that said drippings emitted from said foodstuffs being grilled tend to run toward the lower end of said flame spreading means due to gravitational forces.

28. The system of claim 27, wherein said housing further defines a grease outlet, said apparatus further comprising grease catching means within said housing located below the lower end of said flame spreading means for receiving said drippings that run off the lower end of said flame spreading means, said grease catching means adapted to channel said drippings through said grease outlet.

29. The system of claim 27, wherein said flame spreading means is removable.

30. The system of claim 28, wherein said grease catching means is removable.

31. The system of claim 25, further comprising temperature gauging means attached to said housing for allowing a user to monitor the temperature inside said housing.

32. The system of claim 25, further comprising rolling means connected to a lower end of said frame enabling said housing to be easily transported.

33. The system of claim 25, further comprising a left support surface attached to the left outer side of said frame adjacent to said housing, said left support surface being substantially planar.

34. The system of claim 33, further comprising a right support surface attached to a right outer side of said frame adjacent to said housing, said right support surface being substantially planar.

35. The system of claim 25, wherein said heat source is of the types producing combustion from a gaseous fuel and comprises a perforated pipe adapted to guide said gaseous fuel through the perforations and said apparatus further includes means for connecting said perforated pipe to a source of said gaseous fuel.

36. The system of claim 35, further comprising at least on e adjustable valve mounted to said frame adjacent to said housing allowing adjustment of the amount of said gaseous fuel flowing to said heat source.

37. The system of claim 25, further comprising air channeling means for channeling air from outside said housing to said heat source while isolating the resulting air stream from the foodstuffs being broiled.

38. The system of claim 26, wherein said frame defines a storage chamber.

39. The system of claim 26, wherein said housing is mounted to said frame by way of removable pins such that said housing may be removed from said frame when said removable pins are removed.

40. A method of grilling and broiling foodstuffs simultaneously, said method comprising:
providing a housing defining an enclosure for said foodstuffs and having upper and frontal openings;
mounting a lid to said housing for selectively closing said upper opening;
mounting a door to said housing for selectively closing said lower opening;
disposing a heat source within said housing generally between said upper and lower openings;
disposing an upper grate within said housing above said heat source and below said upper opening;
disposing a lower grate within said housing below said heat source;
depositing said foodstuffs on said upper grate;
depositing said foodstuffs on said lower grate; and
activating said heat source such that it emits heat sufficient to grill said foodstuffs on said upper grate and broil said foodstuffs on said lower grate.

41. The method of claim 40, wherein said heat source emits flames.

42. The method of claim 41, said method further comprising disposing a flame spreader within said housing above said heat source and below said upper grate such that said flames from said heat source impinge upon said flame spreader, said flame spreader adapted to spread said flames substantially evenly below said upper grate, said flame spreader further adapted to receive substantially all drippings that are emitted from foodstuffs being grilled, said flame spreader disposed within said housing at an angled position such that said drippings emitted from said foodstuffs being grilled tend to run toward the lower end of said flame spreader due to gravitational forces.

43. The method of claim 42, said method further comprising:
disposing a grease catcher within said housing below the lower end of said flame spreader such that said grease catcher is adapted to receive said drippings that run off the lower end of said flame spreader; and
wherein said housing further defines a grease outlet, channeling said drippings that run off the lower end of said flame spreader through said grease outlet.

44. The method of claim 40, said method further comprising attaching a thermometer to said housing for allowing a user to monitor the temperature inside said housing.

45. The method of claim 40, said method further comprising mounting said housing to a frame and attaching wheels to a lower end of said frame to enable said housing to be easily transported.

46. The method of claim 40, said method further comprising:
mounting said housing to a frame; and
attaching a left support surface to the left outer side of said frame adjacent to said housing, said left support surface being substantially planar.

47. The method of claim 46, said method further comprising attaching a right support surface to a right outer side of said frame adjacent to said housing, said right support surface being substantially planar.

48. The method of claim 40, wherein said heat source is of the types producing combustion from a gaseous fuel and comprises a perforated pipe adapted to guide said gaseous fuel through the perforations and said apparatus further includes means for connecting said perforated pipe to a source of said gaseous fuel.

49. The method of claim 40, said method further comprising mounting at least one adjustable valve to said frame adjacent to said housing allowing adjustment of the amount of said gaseous fuel flowing to said heat source.

50. The method of claim 40, said method further comprising channeling air from outside said housing to said heat source while isolating the resulting air stream from the foodstuffs being broiled.

51. An apparatus for grilling and broiling foodstuffs, comprising:
a housing;
a flame spreader disposed within said housing dividing said housing into an upper cooking chamber and a lower cooking chamber;
an upper grate disposed within said upper cooking chamber;
a lower grate disposed within said lower cooking chamber; and
a heat source disposed within said lower cooking chamber above said lower grate, wherein said heat source emits flames.

52. The apparatus of claim 51, wherein the flame spreader comprises a plurality of overlapping U-shaped channels secured in a generally parallel relationship and wherein said flame spreader is positioned to spread said flames emitted from said heat source in a substantially even manner below said upper grate.

53. The apparatus of claim 52, wherein the flame spreader is positioned to receive substantially all drippings and grease emitted from the foodstuffs being grilled that fall through said upper grate.
